(19) United States
(12) Patent Application Publication
(10) Pub. No.: US 2003/0156795 A1
(43) Pub. Date: Aug. 21, 2003

(54) Optical power splitter

(76) Inventor: Heu-Gon Kim, Seoul (KR)

Correspondence Address: CHA & REITER, 411 HACKENSACK AVE, 9TH FLOOR, HACKENSACK, NJ, 07601, US

(21) Appl. No.: 10/365,994

(22) Filed: Feb. 13, 2003

(30) Foreign Application Priority Data
Feb. 20, 2002 (KR) 2002-8954

(51) Int. Cl. G02B 6/26

(52) U.S. Cl. 385/45

(57) ABSTRACT

An optical power splitter is disclosed that includes a semiconductor substrate, a core layered on the semiconductor substrate, functioning as a transmission medium for optical signals composed of multi channels according to a wavelength. The core includes an input waveguide for receiving the optical signals, and a plurality of output waveguides for outputting part of the optical signals whose powers are split. A cladding encompasses the core. At least one tapered waveguides, which connect a part of internal sides of the output waveguides have widths that gradually decrease along with a longitudinal direction thereof starting from one end of the output waveguide.

### CLAIM OF PRIORITY

This application claims priority to an application entitled “OPTICAL POWER SPLITTER” filed in the Korean Industrial Property Office on Feb. 20, 2002 and assigned Serial No. 02-8954, the contents of which are hereby incorporated by reference.

### BACKGROUND OF THE INVENTION

1. Field of the Invention

The present invention relates generally to a planar lightwave circuit, and in particular, to an optical power splitter.

2. Description of the Related Art

A planar lightwave circuit (PLC) includes a semiconductor substrate, a core, and cladding encompassing the core. The core, which is layered on the semiconductor substrate, propagates input optical signals using total internal reflection. Typical examples of optical circuits using such planar lightwave circuits, i.e., waveguides, include optical power splitters/combiners for splitting or combining power of optical signal, and wavelength division multiplexers/demultiplexers for multiplexing or demultiplexing channels that compose optical signals according to wavelength.

The structure of an optical power splitter is largely divided into a two-branch structures like a Y-branch waveguide, and a multi-branch structure like a star coupler. FIG. 1 is a schematic diagram of a conventional Y-branch waveguide. The Y-branch waveguide includes an input waveguide 110, a branch waveguide 120, and a first and a second out waveguides 130 and 140.

The input waveguide 110 is a rectilinear waveguide, into which optical signals are input through an input side edge 112. The branch waveguide 120 receives the optical signals through the input side edge 112 that is connected to the input waveguide 110. The width of the branch waveguide 120 increases towards the direction where the optical signals progress.

The first and the second output waveguides 130 and 140 are extended symmetrically around a central line (not shown) of the branch waveguide 120 from an output side edge 124 of the branch waveguide 120. The output of the branch waveguide 120 are split optical signals, respectively to the first and second output waveguides 130 and 140. The optical signals that travel from the input waveguide 110 to the first or the second output waveguide 130 or 140 experience a continuous mode variation.

Virtual edges 150 and 155 (which are perpendicular to a longitudinal direction of the first or the second output waveguide 130 or 140) on the borders of the first and the second output waveguides 130 and 140, and the input waveguide 110 are not parallel to the output side edge 124 of the branch waveguide 120. It is noted that when the output side edge 124 of the branch waveguide 120 and the virtual edges 150 and 155 are not parallel to each other, the mode becomes very unstable. For example, if the width of the input waveguide 110 is 8 μm, and the length of the first and the second output waveguides 130 and 140 is 1500 μm, and an optical signal having a wavelength of 1550 nm is inputted into the Y-branch waveguide. In this case, the optical signal loss amounts to 3.312 dB.

FIG. 2 illustrates a beam profile of optical signals that progress to the Y-branch waveguide shown in FIG. 1. FIG. 3 diagrammatically shows mode profiles of the optical signals that were split on the output side edges 132 and 142 of the first and the second output waveguides 130 and 140 depicted in FIG. 1. From the beam profile of the split optical signals, it can be seen that the split optical signals progress unstably along with the first and the second output waveguides 130 and 140. It is noted that the optical signals become perpendicularly incident on the input side edge 112 of the input waveguide 110.

Referring back to FIG. 3, a first and a second mode profiles 210 and 230 of the split optical signals are shown at the output side edges 132 and 142 of the first and the second output waveguides 130 and 140. As shown, a mode center 215 or 235 of the first or the second mode profile 210 or 230 is separated from central lines 220 and 240 of the first or the second output waveguide 130 or 140 by a designated distance M₁ and M₂. The mode variations M₁ and M₂ have the same value because the optical signals are perpendicularly incident on the input side edge 112 of the input waveguide 110, and the first and the second output waveguides 130 and 140 are symmetrical around the central line of the branch waveguide 120.

This mode instability consequently deteriorates output characteristic of the Y-branch waveguide. To overcome the problem, the first and the second output waveguides 130 and 140 were lengthened. While this may stabilize the mode somewhat, it also increased the size of the entire circuit, which in turn reduces the yield thereof. In addition, in such a configuration it is difficult to perform any process since the branching angle on the basis of a peak point 160 (shown in FIG. 1), a point where internal sides 134 and 144 of the first and the second output waveguides 130 and 140 meet, of the Y-branch waveguide is small. Moreover, depending on the process implementation of the peak point 160, optical characteristics may vary severely.

FIG. 4 is a schematic diagram explaining another conventional Y-branch waveguide. The Y-branch waveguide includes an input waveguide 310, and a first and a second output waveguides 320 and 330.

The input waveguide 310 receives optical signals through an input side edge 312, and outputs the optical signals through an output side edge 314 after splitting the signals. The input waveguide 310 gets broader along with the traveling direction of the optical signals.

The first and the second output waveguides 320 and 330, respectively, receive the split optical signals through an input side edge that is connected to the output side edge 314 of the input waveguide 310. Inner sides 324 and 334 and outer sides of the first and second output waveguides 320 and 330 are bent at a corresponding curvature, forming an arc. The first or the second output waveguide 320 or 330 become gradually wider along with the traveling direction of the split optical signals. The internal sides 324 and 334 of the first and the second output waveguides 320 and 330 are separated from each other by a second space G₂. The outer side of the first output waveguide 320 and the outer side of the input waveguide 310 are separated from each other by a first space G₁. The outer side of the second output waveguide 330 and the outer side of the input waveguide 310 are also separated from each other by the first space G₁. The first and the second output waveguides 320 and 330 are symmetrically formed around the central line of the input waveguide 310.

FIG. 5 is a diagram of a beam profile of optical signals that progress along with the Y-branch waveguide depicted in FIG. 4. FIG. 6 shows mode profiles of the split optical signals manifested on the output side edges 322 and 332 of the first and the second output waveguides 320 and 330 that are shown in FIG. 4. From the beam profile of the split optical signals, it can be seen that the split optical signals travel somewhat stably along with the longitudinal directions of the first and the second output waveguides 320 and 330. It is noted that the input optical signals are perpendicularly incident on the input side edge 312 of the input waveguide 310.

FIG. 6 illustrates a first and a second mode profiles 410 and 430 of the split optical signals shown at the output side edges 322 and 332 of the first and the second output waveguides 320 and 330. As depicted, a mode center 415 or 435 of the first or the second mode profiles 410 or 430, and a central line 420 or 440 of the first or the second output waveguide 320 or 330 almost overlapped each other. The Y-branch waveguide, unlike the Y-branch waveguide of FIG. 1, does not have a peak point, so the process is more successfully reproduced, and the variation of optical characteristics due to process error is insignificant.

Unfortunately however, the optical signals progressing from the input waveguide 310 to the first or the second output waveguide 320 or 330 experience a discontinuous mode variation, and because of that, some optical signals are lost. In addition, the process error in some parts cause light loss, i.e., at the boundaries of the input waveguide 310, and the first and the second output waveguides 320 and 330. More specifically, the increasing mode variation, according to changes in the width of a waveguide and refractive index, makes it difficult to design the boundary parts.

### SUMMARY OF THE INVENTION

One object of the present invention to provide an optical power splitter for improving output characteristic by minimizing mode instability and light loss.

Another object of the present invention is to provide an optical power splitter for improving output characteristic by minimizing light loss, and by minimizing yield reduction due to a process error that can be overcome by relieving sensitivity to the process error.

One embodiment of the present invention is directed to an optical power splitter, including a semiconductor substrate and a core layered on the semiconductor substrate. The core functions as a transmission medium for optical signals composed of multi channels according to a wavelength. The core includes an input waveguide for receiving the optical signals and a plurality of output waveguides for outputting part of the optical signals whose powers are split. A cladding is used to encompass the core. The core also includes at least one tapered waveguide, which connects a part of internal sides of nearby output waveguides, and whose width gradually decreases along with a longitudinal direction thereof starting from one end of the output waveguide.

Another aspect of the present invention is directed to an optical power splitter, including a semiconductor substrate, a core layered on the semiconductor substrate, functioning as a transmission medium for optical signals and a clad for encompassing the core. The core includes an input waveguide for receiving optical signals through the input side edge, and a first and a second output waveguides extended from an output side edge of the input waveguide, respectively, whose opposite internal sides having a designated curvature that meet together on the output side edge of the input waveguide and whose input side widths divide the output side widths of the input waveguide by two, output split optical signals, respectively.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram of a conventional Y-branch waveguide;

FIG. 2 is a diagram illustrating a beam profile of optical signals that travel the Y-branch waveguide depicted in FIG. 1;

FIG. 3 is a diagram illustrating mode profiles of optical signals that are split on output side edges of the first and the second output waveguides shown in FIG. 1;

FIG. 4 is a schematic diagram of another conventional Y-branch waveguide;

FIG. 5 is a diagram illustrating a beam profile of optical signals that travel the Y-branch waveguide depicted in FIG. 4;

FIG. 6 is a diagram illustrating mode profiles of optical signals that are split on output side edges of the first and the second output waveguides shown in FIG. 4;

FIG. 7 is a schematic diagram of a Y-branch waveguide in accordance with a first embodiment of the present invention;

FIG. 8 is a diagram illustrating a beam profile of optical signals that travel the Y-branch waveguide depicted in FIG. 7;

FIG. 9 is a diagram illustrating mode profiles of optical signals that are split on output side edges of the first and the second output waveguides shown in FIG. 7;

FIG. 10 is a schematic diagram of a Y-branch waveguide in accordance with a second embodiment of the present invention;

FIG. 11 is an enlarged view of a portion “A” depicted in FIG. 10;

FIG. 12 is a diagram illustrating a beam profile of optical signals that travel the Y-branch waveguide depicted in FIG. 10;

FIG. 13 is a diagram illustrating mode profiles of optical signals that are split on output side edges of the first and the second output waveguides shown in FIG. 10;

FIG. 14a-FIG. 14d are exemplary views showing loss variation due to curvature variation of the first and the second output waveguides depicted in FIG. 10;

FIG. 15 is a schematic diagram of a Y-branch waveguide in accordance with a comparative example of the present invention;

FIG. 16 is a diagram illustrating a beam profile of optical signals that travel the Y-branch waveguide depicted in FIG. 15; and

FIG. 17 is a diagram illustrating mode profiles of optical signals that are split on output side edges of the first and the second output waveguides shown in FIG. 15.

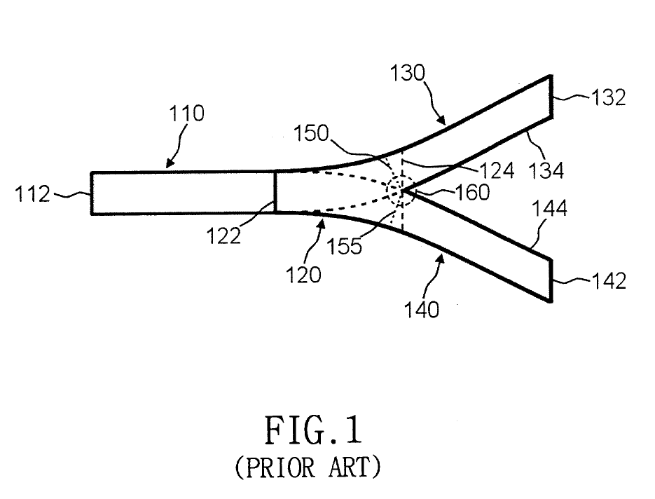

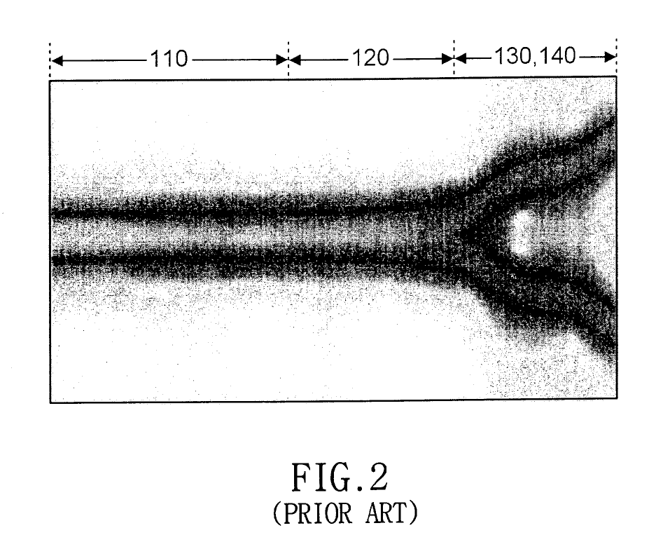

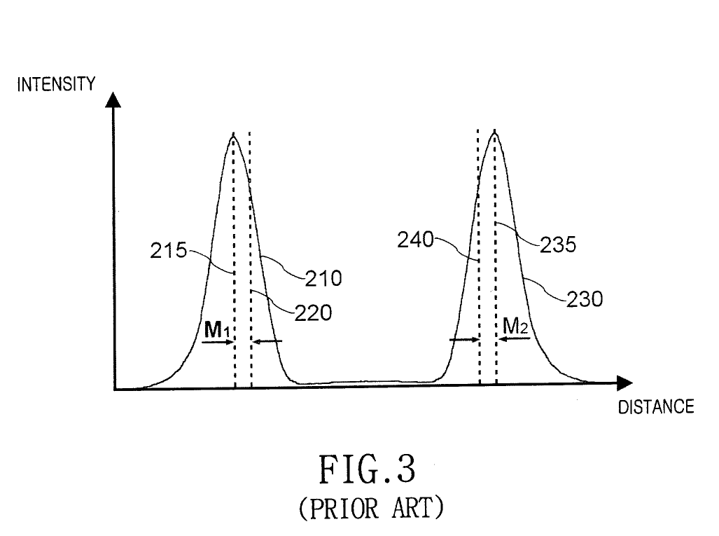

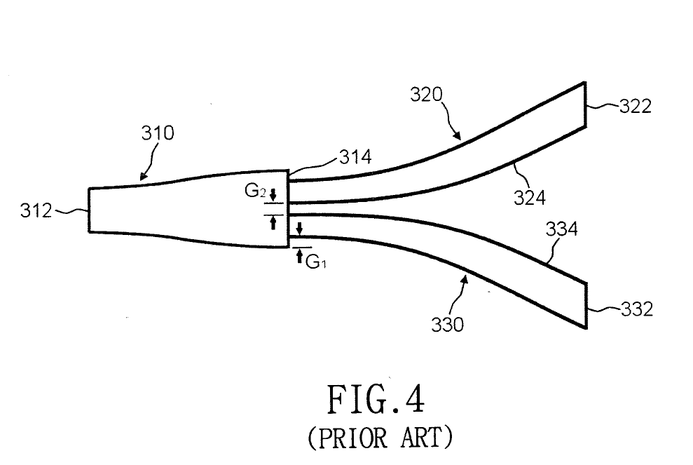

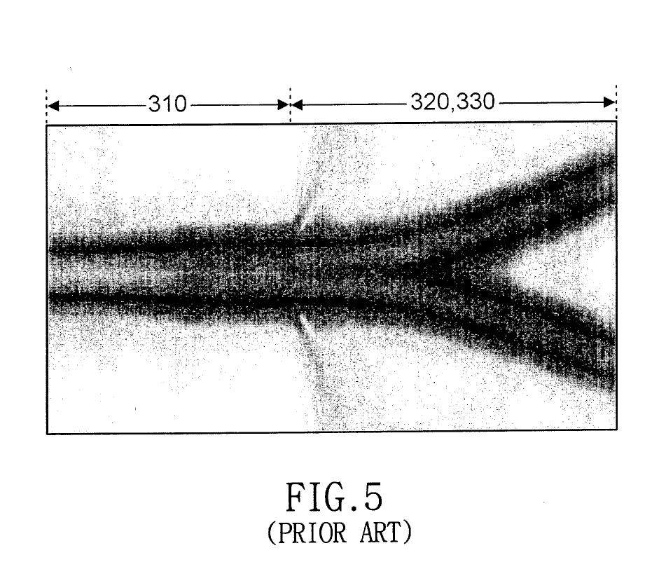

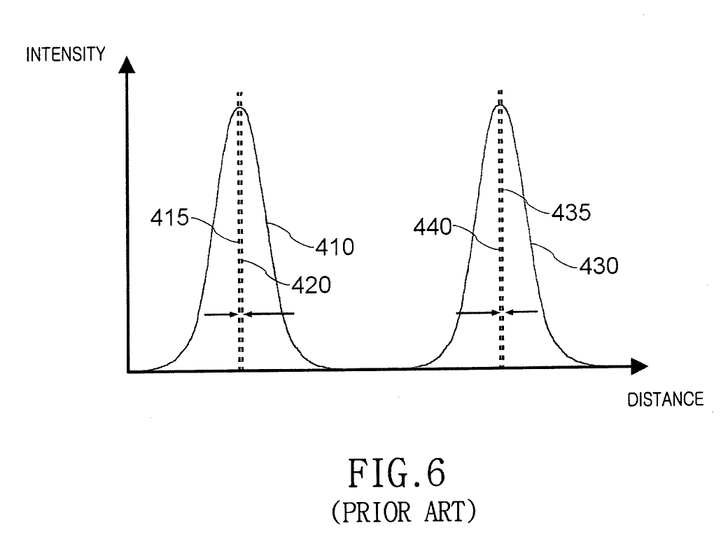

### DETAILED DESCRIPTION OF THE PREFERRED EMBODIMENT

Various embodiments of the present invention will be described herein below with reference to the accompanying drawings. In the following description, well-known functions, devices, elements or constructions are not described in detail since they would obscure the invention in unnecessary detail.

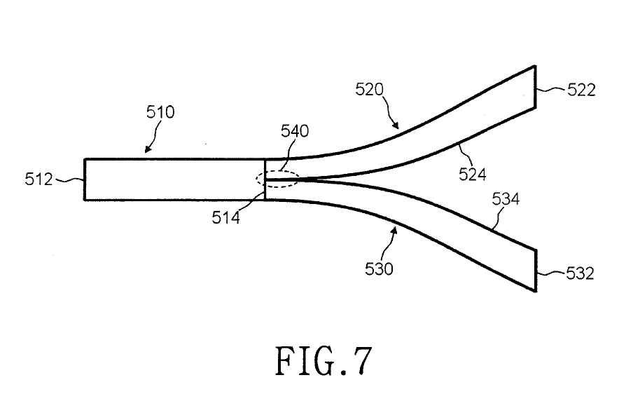

FIG. 7 diagrammatically illustrates the structure of a Y-branch waveguide in accordance with a first embodiment of the present invention. The Y-branch waveguide is a PLC circuit, and is formed by layering a core having a high refractive index and a clad having a low refractive index for encompassing the core upon the substrate. The core includes an input waveguide 510, and a first and a second output waveguides 520 and 530.

The input waveguide 510 receives optical signals through its input side edge 512. The input optical signals are split and then output through an output side edge 514. As shown in this embodiment, the input waveguide 510 is a rectilinear waveguide, whose width from the input side edge 512 to the output side edge 514 is constant.

The first and the second output waveguide 520 and 530 are extended from the output side edge 514 of the input waveguide 510, respectively. More specifically, they are extended bilaterally and symmetrically around a central line (not shown) of the input waveguide 510. The first or the second output waveguides 520 and 530 gradually becomes wider starting from an input side edge which is fed by the output side edge 514 of the input waveguide 510 to an outside edge 522 or 532. The growth should be substantially constant along the length of the first or second output waveguide 520 and 530. The first and second output waveguides 520 and 530 have an internal sides 524 and 534, respectively. The outer side of the first and second output waveguides 520 and 530 are bent to a corresponding curvature, and form an arc The opposite internal sides 524 and 534 of the first and the second output waveguides 520 and 530 meet together at the output side edge 514 of the input waveguide 510. A peak point 540 of the opposite internal sides 524 and 534 is located on the output side edge 514 of the input waveguide 510. The input side widths of the first and the second output waveguides 520 and 530 divide the width of the input waveguide 510 by two, and output split optical signals, respectively.

It is noted that the optical signals traveling from the input waveguide 510 to the first or the second output waveguide 520 or 530 experience a continuous mode variation. Moreover, the virtual edges (not shown) on the boundaries of the first and the second output waveguide 520 and 530, and the input waveguide 510 (here, the virtual edges are perpendicular to a longitudinal direction of the first or the second output waveguide 520 or 530) overlap with the input side edges of the first and the second output waveguides 520 and 530. The input side edges of the first and the second output waveguides 520 and 530 are parallel to the output side edge 514 of the input waveguide 510. Therefore, no further loss is resulted from the inconsistency between the virtual edge and the input side edge of the first or the second output waveguide 520 or 530. For example, in case where the width of the input waveguide 510 is 8 μm, and the length of the first and the second output waveguides 520 and 530 is 1500 μm, and an optical signal having a wavelength of 1550 nm is input into the Y-branch waveguide shown in FIG. 7, the optical signal loss measured is 3.010 dB.

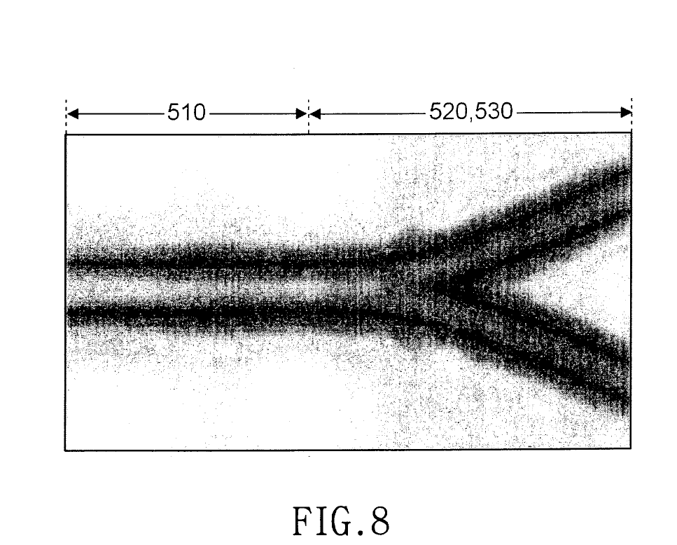

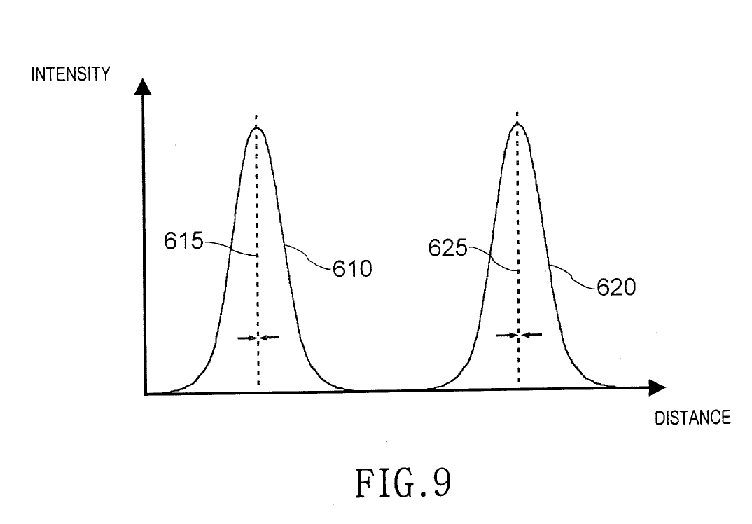

FIG. 8 diagrammatically illustrates a beam profile of optical signals that travel at the Y-branch waveguide depicted in FIG. 7. FIG. 9 diagrammatically illustrates mode profiles of optical signals that are split on output side edges 522 and 532 of the first and the second output waveguides 520 and 530 shown in FIG. 7. It can be seen from the beam profile of the split optical signals that the split optical signals stably progress along with the longitudinal direction of the first and the second output waveguides 520 and 530. It is noted that the input optical signals are perpendicularly incident upon the input side edge 512 of the input waveguide 510.

Depicted in FIG. 9 are a first and a second mode profiles 610 and 620 of the split optical signals that are shown on the output side edges 522 and 532 of the first and the second output waveguides 520 and 530. As shown in the drawing, a mode center 615 or 625 of the first or the second mode profile 610 or 620 is consistent with the central line of the first or the second output waveguide 520 or 530, i.e., mode matching occurs.

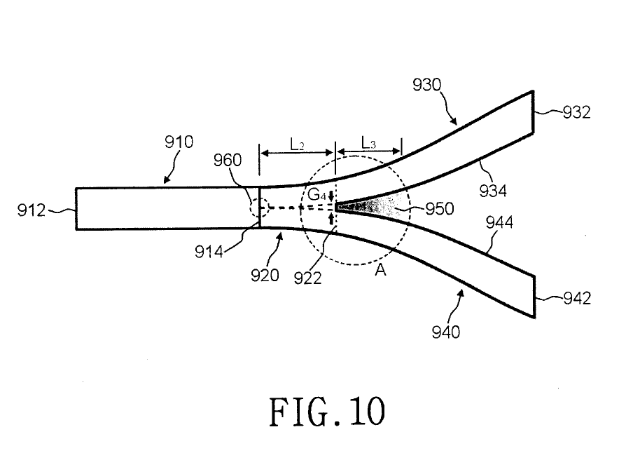

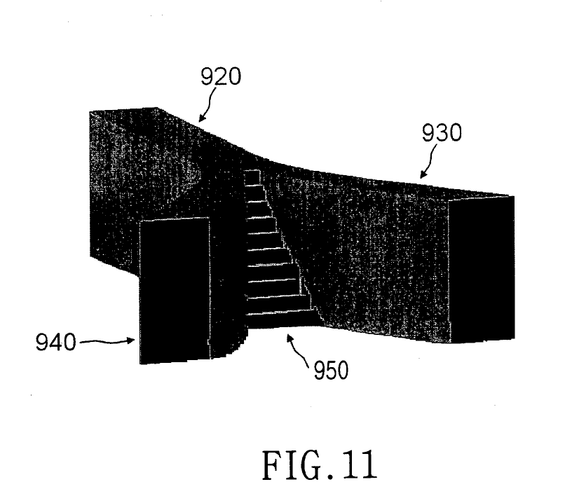

FIG. 10 is a schematic diagram of a Y-branch waveguide according to a second embodiment of the present invention. FIG. 11 is an enlarged view of a portion “A” shown in FIG. 10. In this embodiment, the Y-branch waveguide includes an input waveguide 910, a branch waveguide 920, a tapered waveguide 950, and a first and a second output waveguides 930 and 940.

Similar to the first embodiment, the input waveguide 910 receives optical signals through an input side edge 912. The input optical signals output through an output side edge 914. The input waveguide 910 is a rectilinear waveguide, whose width from the input side edge 912 to the output side edge 914 is constant.

The branch waveguide 920 receives optical signals through an input side edge connected to the output side edge 914. The input optical signals are split and output through an output side edge 922. The branch waveguide 920 has a designated length, L₂, and its width is gradually increased toward the traveling direction of the optical signals. The increase in width is substantially constant along the length of the branch waveguide 920.

The first and the second output waveguides 930 and 940, respectively, receive the split optical signals through an input side edge that is connected to the output side edge 922 of the branch waveguide 920. The first and second output waveguides 930 and 940 have internal sides 934 and 944 and outer sides that are bent to a corresponding curvature, and form an arc together. The width of the first or the second output waveguide 930 or 940 is gradually increased toward the progress direction of the split optical signals. The internal sides 934 and 944 of the first and the second output waveguides 930 and 940 are separated from each other by a fourth space G₄.The first and the second output waveguides 930 and 940 are also symmetric around a central line (not shown) of the input waveguide 910. If the internal sides 934 and 944 of the first and the second output waveguides 930 and 940 are extended toward the input waveguide 910 along with the corresponding curvature, they meet together or converge at the output side edge 914 of the input waveguide 910. A virtual peak point 960 is formed on the output side edge 914 of the input waveguide 910.

The tapered waveguide 950 connects part of the internal sides 934 and 944 of the first and the second output waveguides 930 and 940. The tapered waveguide 950 has a designated length, L₃, and its width is gradually decreased (see, e.g., FIG. 11) from the input side edge of the first and the second output waveguides 930 and 940 along with the longitudinal direction thereof. The decrease in width is substantially constant along the length of the tapered waveguide 950.

As shown in FIG. 11, the tapered waveguide 950 has a tilted shape to reduce its width continuously. The optical signals traveling at the branch waveguide 920 are gradually branched toward the first and the second output waveguides 930 and 940 by the tapered waveguide 950. The optical signals progressing from the branch waveguide 920 to the first or the second output waveguide 930 or 940 experience a gradual mode variation. Accordingly, the mode variation owing to the process error, i.e., the changes in the width and the refractive index of the waveguide, at the boundaries of the branch waveguide 920, and the first and the second output waveguides 930 and 940 is small. For example, in the case where the width of the input waveguide 510 is 8 μm, and the length of the first and the second output waveguides 520 and 530 is 1500 μm, and an optical signal having a wavelength of 1550 nm is input into the Y-branch waveguide, then the optical signal loss measured is 3.025 dB.

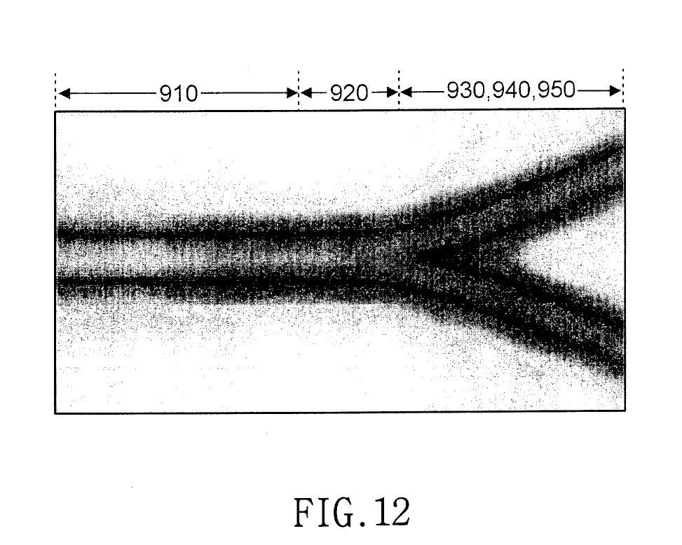

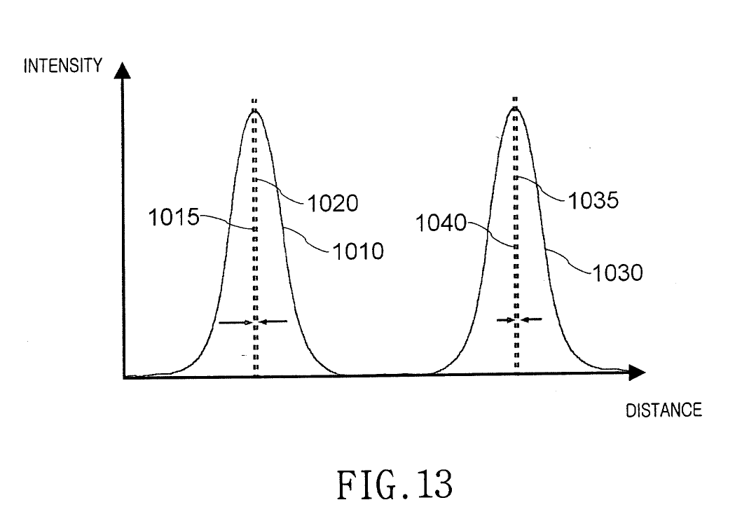

FIG. 12 is a diagram illustrating a beam profile of optical signals that travel the Y-branch waveguide depicted in FIG. 10. FIG. 13 is a diagram illustrating mode profiles of optical signals that are split at output side edges 932 and 942 of the first and the second output waveguides 930 and 940 shown in FIG. 10. From the beam profile of the split optical signals it can be seen that the split optical signals stably progress along with the longitudinal direction of the first and the second output waveguides 930 and 940. It is noted that the inputted optical signals are perpendicularly incident upon the input side edge 912 of the input waveguide 910.

Illustrated in FIG. 13 are a first and a second mode profiles 1010 and 1030 of the split optical signals that are shown at the output side edges 932 and 942 of the first and the second output waveguides 930 and 940. As shown in FIG. 13, a mode center 1015 or 1035 of the first or the second mode profile 1010 or 1030 is almost consistent with the central line (1020 or 10040) of the first or the second output waveguide 930 or 940.

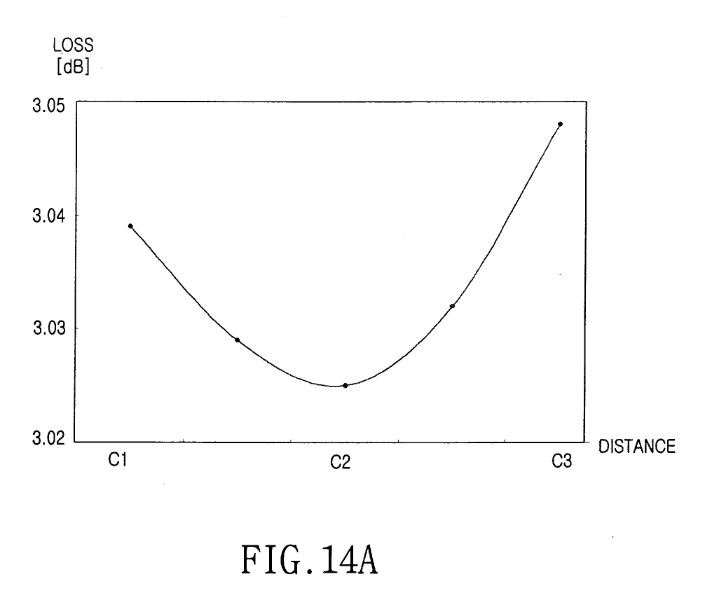

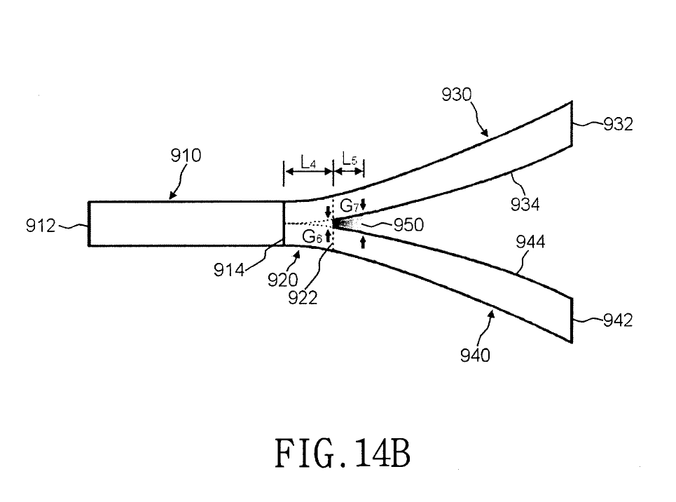

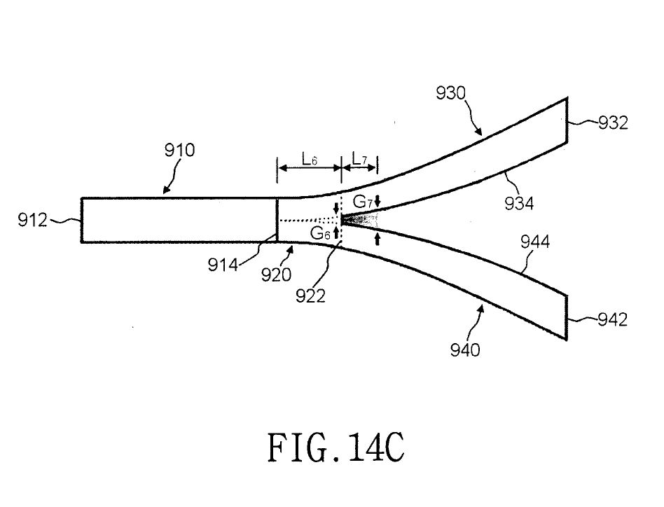

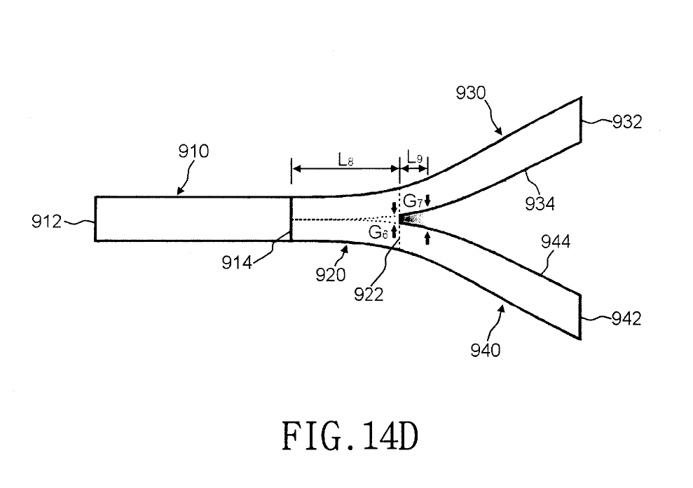

FIG. 14a through FIG. 14d are exemplary views showing loss variation due to the curvature variation of the first and the second output waveguides depicted in FIG. 10. The internal sides 934 and 944 of the first and the second output waveguides 930 and 940 depicted in FIG. 14b have a designated curvature, C₁, and the internal sides 934 and 944 depicted in FIG. 14c have a designated curvature, C₂, and the internal sides 934 and 944 depicted in FIG. 14d have a designated curvature, C₃(C₃>C₂>C₁). In FIG. 14a through FIG. 14d, the minimum width, G₆ and the maximum width, G₇ of the tapered waveguide 950 are constant. As the curvature of the internal sides 934 and 944 is increased(C₁→C₂→C₃), the length of the branch waveguide 920 is increased(L₄→L₆→L₈, wherein L₄<L₆<L₈), and the length of the tapered waveguide 950 is increased then decreased(L₅→L₇→L₉, wherein L₉<L₅<L₇). According to the above variations, light loss of the Y-branch waveguide varies as depicted in FIG. 14a. That is, the optimum curvature, C₂, exits for the first and the second output waveguides 930 and 940 for minimizing light loss of the Y-branch waveguide.

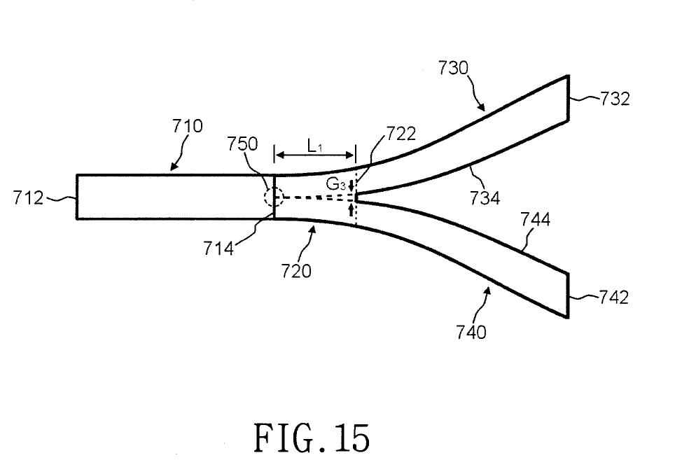

FIG. 15 is a schematic diagram of a Y-branch waveguide in accordance with a comparative example of the present invention. The Y-branch waveguide includes an input waveguide 710, a branch waveguide 720, and a first and a second output waveguides 730 and 740.

The input waveguide 710 receives optical signals through an input side edge 712. The input optical signals are split and output through an output side edge 714. The input waveguide 710 is a rectilinear waveguide, whose width from the input side edge 712 to the output side edge 714 is constant.

The branch waveguide 720 receives optical signals through an input side edge connected to the output side edge 714. The input optical signals are split and output through an output side edge 722. The width of the branch waveguide 920 is gradually increased toward the traveling direction of the optical signals. The increase in width is substantially constant along the length of the branch waveguide 920.

The first and the second output waveguides 730 and 740, respectively, receive the split optical signals through an input side edge that is connected to the output side edge 722 of the branch waveguide 720, and their internal side 734 or 744 and an outer side are bent to a corresponding curvature, and form an arc together. The width of the first or the second output waveguide 730 or 740 is gradually increased toward the progress direction of the split optical signals. The internal sides 734 and 744 of the first and the second output waveguides 730 and 740 are separated from each other by a third space G₃. The first and the second output waveguides 730 and 740 are symmetric around the central line (not shown) of the input waveguide 710. If the internal sides 734 and 744 of the first and the second output waveguides 730 and 740 are extended toward the input waveguide 710 along with the corresponding curvature, they meet together or converge on the output side edge 714 of the input waveguide 710. A virtual peak point 750 is formed on the output side edge 714 of the input waveguide 710.

At the input waveguide 710, the optical signals progressing to the first or the second output waveguides 730 or 740 experience a discontinuous mode variation, and as the result thereof, some optical signals are lost. For example, in the case where the width of the input waveguide 710 is 8 μm, and the length of the first and the second output waveguides 730 and 740 is 1500 μm, and an optical signal having a wavelength of 1550 nm is inputted into the Y-branch waveguide, then the optical signal loss measured is 3.062 dB.

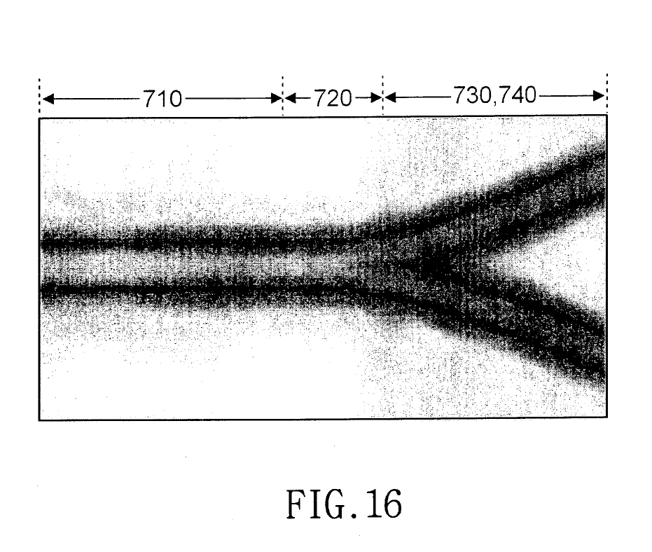

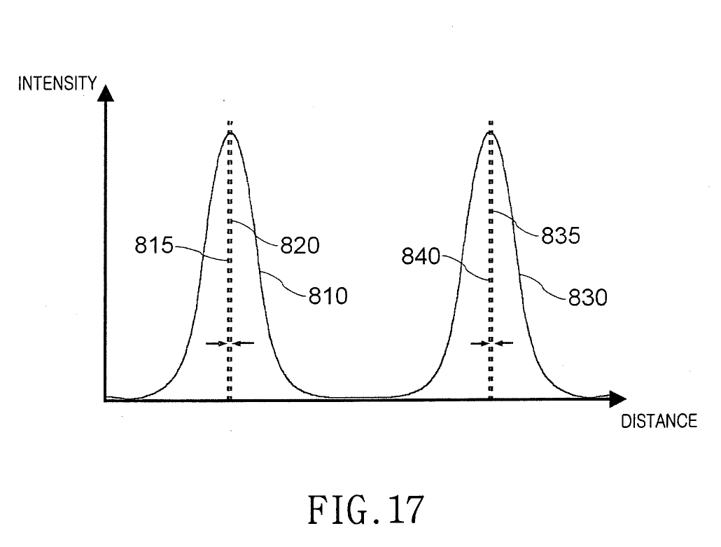

FIG. 16 is a diagram illustrating a beam profile of optical signals that travel the Y-branch waveguide depicted in FIG. 15. FIG. 17 is a diagram illustrating mode profiles of optical signals that are split at output side edges of the first and the second output waveguides 730 and 740 shown in FIG. 15. From the beam profile of the split optical signals, it can be seen that the split optical signals stably progress along with the longitudinal direction of the first and the second output waveguides 730 and 740. It is noted that the inputted optical signals are perpendicularly incident upon the input side edge 712 of the input waveguide 710.

Illustrated in FIG. 17 are a first and a second mode profiles 810 and 830 of the split optical signals that are shown on the output side edges 734 and 744 of the first and the second output waveguides 730 and 740. As shown in FIG. 17, a mode center 815 or 835 of the first or the second mode profile 810 or 830 is almost consistent with the central line 820 or 840 of the first or the second output waveguide 730 or 740.

In conclusion, the described optical power splitter embodiments of the present invention allow the input waveguide's mode and the first and the second output waveguides to be consistent to one another. This allow the embodiments of the present invention to improve output characteristics by minimizing mode instability and light loss that are usually caused by the mode inconsistency.

In addition, the optical power splitter embodiments of the present invention allow for the separation the first output waveguide and the second output waveguide using a tapered waveguide, which relieves the optical power splitter's sensitivity to the process error, and further minimizes the yield reduction due to the process error. In this manner, the light loss is also minimized, and the output characteristics are greatly improved.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An optical power splitter, comprising:
a semiconductor substrate;
a core layered on the semiconductor substrate, functioning as a transmission medium for optical signals that include multi-channels according to a wavelength, wherein the core includes an input waveguide for receiving the optical signals, and at least two output waveguides for outputting part of the optical signals whose powers have been split;
a clad for encompassing the core; and
at least one tapered waveguide, which connects a part of internal sides of the at least two output waveguides, a width of the at least one tapered waveguide gradually decreases to zero along with a longitudinal direction thereof starting from one end of the at least two output waveguides.

2. The optical power splitter as claimed in claim 1, further comprising a branch waveguide disposed inbetween the input waveguide and the at least two output waveguides, in which a width of the branch waveguide gradually increases along with a traveling direction of the optical signals.

3. The optical power splitter as claimed in claim 1, wherein the tapered waveguide has a tilted shape to continuously reduce the width thereof.

4. An optical power splitter, comprising:
a semiconductor substrate;
a core layered on the semiconductor substrate, functioning as a transmission medium for optical signals; and
a clad for encompassing the core,
wherein the core includes:
an input waveguide for receiving optical signals through an input side edge; and
a first and a second output waveguides extending from an output side edge of the input waveguide, respectively, whose opposite internal sides having a designated curvature and meet together on the output side edge of the input waveguide and whose input side widths divide the output side width of the input waveguide by two, and output split optical signals, respectively.
